(19) United States
(12) Patent Application Publication
(10) Pub. No.: US 2006/0013182 A1
(43) Pub. Date: Jan. 19, 2006

(54) Selective multicarrier CDMA network

(75) Inventors: Srinivasan Balasubramanian, San Diego, CA (US); Young C. Yoon, San Diego, CA (US)

Correspondence Address: COATS & BENNETT, PLLC, P O BOX 5, RALEIGH, NC, 27602, US

(73) Assignee: Telefonaktiebolaget LM Ericsson

(21) Appl. No.: 11/021,173

(22) Filed: Dec. 23, 2004

Related U.S. Application Data
(60) Provisional application No. 60/588,975, filed on Jul. 19, 2004.

(51) Int. Cl. H04J 1/00

(52) U.S. Cl. 370/343

(57) ABSTRACT

A multicarrier CDMA system allows the number of carrier frequencies supporting a connection to be dynamically varied. The packet stream is divided into one or more substreams depending on the selected number of carrier frequencies and each substream is transmitted on a corresponding carrier frequency. The number of carrier frequencies is selectively varied during transmission of said packet data.

### RELATED APPLICATIONS

This application claims priority to Provisional U.S. Patent Application 60/588,975 filed Jul. 19, 2004, which is incorporated herein by reference.

### BACKGROUND OF THE INVENTION

The present invention relates generally to wireless communication networks, and more particularly, to a selective multicarrier CDMA network.

The cdma2000 radio channels are designed to permit multicarrier operation in the same spectrum as existing 2G networks based on the IS95 standard. The cdma2000 standard defines two spreading rates—spreading rate 1 (SR1) and spreading rate 2 (SR2). SR1 implies a single radio channel system with a total bandwidth of 1.25 MHz and a chip rate of 1.228 Mcps. SR2 denotes a multicarrier system with a bandwidth of 3.75 MHz. The forward link in multicarrier cdma2000 uses three separate direct-spread carriers, each spread at a chip rate of 1.288 Mcps. The reverse link of multicarrier cdma2000 combines three cdma2000 radio channels to create a single carrier with a bandwidth of 3.75 MHz.

The existing multicarrier framework for cdma2000 has a number of drawbacks. First, the cdma2000 standard makes no provision for varying the number of carriers during transmission. Once a communication link between a mobile station and BS is established, the number of carriers (either 1× or 3×) supporting the connection is fixed. Second, the cdma2000 standard requires contiguous radio channels for a 3× carrier for both forward and reverse links. Moreover, only 1× is supported for the forward packet data channel (F-PDCH) in the IS-2000 Rev C and D and IS-856 standards.

### SUMMARY OF THE INVENTION

A multicarrier CDMA system is provided that allows the number of carriers supporting a connection to be dynamically varied during active packet data communications. A new multicarrier sublayer is added to the cdma2000 protocol stack to divide and recombine packet data streams. In one embodiment of the invention, the packet data stream from the RLP sublayer is divided into multiple streams depending on the number of carrier frequencies supporting forward and reverse link communications. Each substream is separately coded and modulated, and transmitted over a corresponding carrier frequency. The number of carrier frequencies supporting forward and reverse link communications can be different.

In one embodiment of the invention, one carrier frequency may be designated as an anchor frequency with the remaining carrier frequencies serving as supplemental frequencies. Circuit-swtiched voice and data are carried only on the anchor frequency. Packet-swtiched data may be carried on both the anchor frequency and supplemental frequencies. At any given time, there is only one anchor frequency, but the anchor frequency may be changed over time.

The present invention does not require any modifications in the physical layer of existing standards. Therefore, it is possible to make a multicarrier system by combining carrier frequencies supporting different air interfaces. In one embodiment of the invention, the channel structure of the anchor frequency conforms to the IS2000 standard, while the channel structure of the supplemental frequencies conforms to the IS856 standard. Alternatively, the supplemental frequencies may comprise a data only carrier with a newly-defined channel structure to transport data more efficiently. The present invention, however, is not limited to use of particular standards.

In one embodiment of the invention, the supplemental carrier frequencies may comprise data only carriers. All related control information is carried over the anchor frequency for all carriers. Network operators may define new channel structures for the data only carriers frequencies without the burden of defining physical channels to carry control information.

The ability to dynamically vary the number of carriers supporting a connection provides greater flexibility in resource allocation. Further, the present invention does not require the carriers supporting a connection to be contiguous. Backward compatibility with existing 2G and 3G systems is preserved while providing a migration path for new multicarrier CDMA technology.

### BRIEF DESCRIPTION OF THE DRAWINGS

FIG. 1 illustrates protocol layers for a multicarrier CDMA network according to one exemplary embodiment of the present invention.

FIG. 2 illustrates the carrier frequencies in a multicarrier CDMA network according to one exemplary embodiment of the present invention.

FIG. 3 illustrates the carrier frequencies in a multicarrier CDMA network according to another exemplary embodiment of the present invention.

FIG. 4 illustrates the carrier frequencies in a multicarrier CDMA network according to another exemplary embodiment of the present invention.

FIG. 5 illustrates a multicarrier CDMA network according to one embodiment of the present invention.

FIG. 6 illustrates a transmitter for a mobile station and/or base station according to one exemplary embodiment of the present invention.

FIG. 7 illustrates a receiver for a mobile station and/or base station according to one exemplary embodiment of the present invention.

FIG. 8 illustrates a multicarrier sublayer for a multicarrier CDMA network for dividing a RLP stream into multiple substreams according to one embodiment of the present invention.

FIG. 9 illustrates protocol layers for a multicarrier CDMA network with mixed air interfaces according to one exemplary embodiment of the present invention.

FIG. 10 illustrates protocol layers for a multicarrier CDMA network with mixed air interfaces according to another exemplary embodiment of the present invention.

### DETAILED DESCRIPTION OF THE INVENTION

The physical layer channelization for cdma2000 networks is designed to allow backward compatibility with 2G systems and gradual multicarrier deployment in the same spectrum. A conventional cdma2000 radio channel is 1.25 MHz. For multicarrier CDMA, multiple cdma2000 radio channels are used to support a single connection. A “1×” system uses a single cdma2000 radio channel spread at a chip rate of 1.228 Mcps occupying 1.25 MHz of bandwidth. A “3×” system uses three cdma2000 radio channels occupying 3.75 MHz of bandwidth. The forward link in multicarrier cdma2000 uses three separate direct-spread carriers, each spread at a chip rate of 1.288 Mcps. The reverse link of multicarrier cdma2000 combines three cdma2000 radio channels to create a single carrier with a bandwidth of 3.75 MHz.

The existing multicarrier framework for cdma2000 has a number of drawbacks. First, the cdma2000 standard makes no provision for varying the number of carriers during transmission. Once a communication link between a mobile station and BS is established, the number of carriers (either 1× and 3×) supporting the connection is fixed. Second, the cdma2000 standard requires contiguous radio channels for a 3× carrier.

According to the present invention, a multicarrier CDMA system is provided that allows the number of carriers supporting a connection to be dynamically varied. The present invention may be implemented in stages. In a first stage, changes are made only in layer 3 to support dynamic allocation of carrier frequencies. In a second stage, modifications may be made to the MAC protocols and/or new control channels may be added to optimize behavior. For example, load-balancing functions may be added to the MAC layer to balance the load across multiple carriers. In the third stage, new physical channels may be defined, such as a data only carrier to make data transfer more efficient.

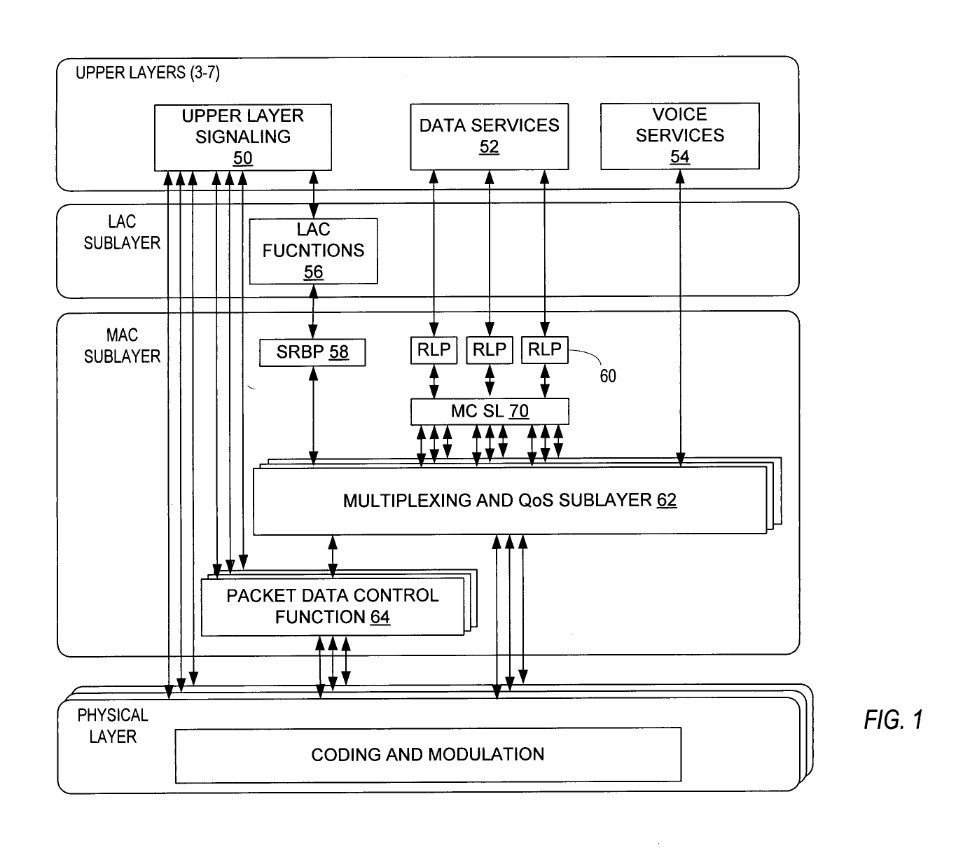

FIG. 1 illustrates exemplary modifications to the cdma2000 protocol according to one embodiment of the present invention. The layering of the protocol stack generally follows the Open Systems Interconnection (OSI) reference model. The protocol layers include the physical layer (Layer 1), the link layer (Link 2), and upper layers (Layers 3-7). The link layer includes Medium Access Control (MAC) and Link Access Control (LAC) sublayers. Except as noted below, the functional entities described conform to the cdma2000 standard. While the cdma2000 protocol stack is used herein to illustrate the present invention, those skilled in the art will appreciate that the present invention may also be used in networks based on other standards.

The upper layers provide three basic services—upper layer signaling 50, data services 52, and voice services 54. Upper layer signaling 50, which resides in the signaling layer (Layer 3), comprises base station and mobile station interoperability procedures. The upper layer signaling function 50 performs call processing to set up, maintain, and release connections. The upper layer signaling function 50 is also responsible for mobility management, user identification, and security. Layer 3 also includes messaging needed to support packet data services. Voice services 52 and data services 54 are higher layer services that, as the names imply, provide circuit-switched voice services and packet-switched data services, respectively.

The LAC sublayer provides services to the signaling layer (Layer 3). The LAC sublayer includes protocols for the transmission of signaling messages across the MAC sublayer. The LAC sublayer includes a number of LAC functions 56 which assure reliable delivery of signaling data units (SDUs) to Layer 3, generate packet data units (PDUs) to transport SDUs, and perform segmentation and reassembly of LAC PDU, authentication, and address control. These functions are not material to the present invention and therefore are not described herein.

The MAC sublayer provides reliable transport of user data over the radio link. The MAC sub layer allows multiple data service state machines, one for each packet or circuit-switched data application used in an active session. The reliable transmission of user data is made possible by the radio link protocol (RLP) sublayer 60, which implements a specialized form of selective repeat automatic repeat request (ARQ) protocol. The Signaling Radio Burst Protocol (SRBP) 58 provides best effort delivery of Layer 3 signaling information. The MAC sublayer further includes a multiplexing and QoS sublayer 62 that performs multiplexing of logical data and signaling channels onto physical channels and provides quality of service (QoS) management for each active service. The MAC sublayer also includes a packet data control function 64 that performs, among other things, rate control for forward and reverse packet data channels.

The physical layer defines the air interface and contains the communication channels by which a base station and mobile station communicate. The physical layer performs coding, modulation, and spreading of signals for transmission, and decoding, demodulation, and dispreading of received signals. The cdma2000 standard specifies both dedicated channels, e.g. fundamental channels and supplemental channels, for voice and low to moderate speed packet data, and shared packet data channels for high speed packet data communications. An advantage of the present invention is that no changes in the physical layer are required because the division of the RLP stream occurs in higher layers of the protocol stack.

As can be seen in FIG. 1, a new multiplexing sublayer, referred to herein as the multicarrier (MC) sublayer 70 is interposed between the RLP sublayer 60 and multiplexing and QoS sublayer 62. Alternatively, the RLP sublayer 60 could be modified to incorporate the function of the MC sublayer 70. The MC sublayer 70 divides a single RLP stream into multiple substreams for forward link traffic and reassembles multiple substreams into a single RLP stream for reverse link traffic. As will be described in greater detail below, each substream is transmitted over a different carrier. The MC sublayer 70 incorporates load balancing and flow control mechanisms to distribute RLP packets across multiple carriers as will be hereinafter described. The MAC functions below the MC sublayer 70, including the multiplexing and QoS sublayer 62 and packet data control function 64, are duplicated for each carrier frequency. The multiplexing and QoS sublayer 62 for each carrier frequency is independent of the other carrier frequencies so the information carried by the different carrier frequencies will typically be different. A separate physical layer is also defined for each carrier frequency. Each RLP substream is separately coded and modulated. The separate physical layers ensure backward compatibility with existing 2G systems.

The physical layer channel structure for different carrier frequencies may be the same or may be different. In one embodiment of the invention, one of the carrier frequencies is designated as an anchor frequency. The anchor frequency contains legacy circuit-switched channels to maintain backward compatibility with existing 2G networks. The anchor frequency may also include channels designed to carry packet-switched data. The remaining carrier frequencies, referred to herein as supplemental carrier frequencies, include channel structures that are designed to carry packet-switched data.

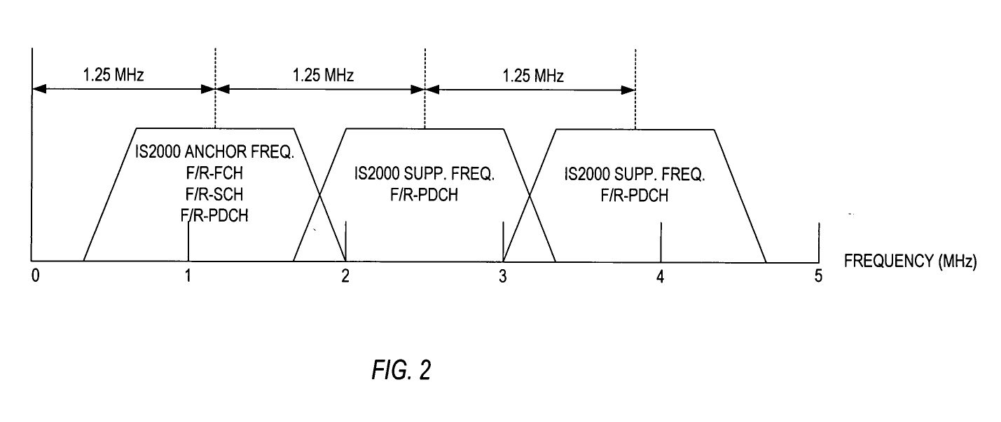

FIG. 2 illustrates an exemplary multicarrier system with three carrier frequencies, although those skilled in the art will appreciate that the multicarrier CDMA system according to the present invention may have more carrier frequencies. The anchor frequency includes channel structures conforming to existing cdma2000 standards. The anchor frequency includes a full array of circuit-switched and packet-switched channels as specified in Revisions C and D of the cdma2000 standard. The anchor frequency includes forward and reverse fundamental channels (F/R-FCH), supplemental channels (F/R-SCH), and common control channels to preserve backward compatibility with 2G networks. The anchor frequency further includes forward and reverse packet data channels (F/R-PDCH) and associated control channels to provide high speed packet data services as specified in Revisions C and D of the cdma2000 standard. The supplemental carrier frequencies include F/R-PDCHs and associated control channels conforming to the cdma2000 standard without any dedicated channels. Revisions C and D of the cdma2000 standard are generally known as 1×EV-DV. Therefore, the F/R-PDCHs and associated control channels as specified in Revisions C and D of the cdma2000 standard are referred to herein as DV channels.

Using the channel structures shown in FIG. 2, circuit-switched voice and data is carried only over the anchor frequency and the supplemental carrier frequencies are used only for packet-switched data traffic. The anchor frequency also carries packet-switched data traffic over DV channels. Those skilled in the art will appreciate, however, that each carrier frequency could include the full array of cdma2000 channels the same as the anchor frequency. When two or more carrier frequencies include circuit switched channels, the circuit switched channels on each separate carrier frequency should be independent. That is, there is no multiplexing of circuit switched channels across multiple carriers. This limitation is necessary to maintain backward compatibility with existing cdma2000 standards.

The number of possible carrier frequencies for forward and reverse links may be different. In general, more data is transmitted on the forward link than on the reverse link. Therefore, the pool of available carrier frequencies for the forward link may be larger than the pool of available carrier frequencies for the reverse link. The same carrier frequencies may be used for both forward and reverse links. However, some carrier frequencies may be used for only forward link or reverse link communications. The carrier frequencies for reverse link communications may be a subset of the carrier frequencies for forward link communications. The selective multicarrier transmission scheme of the present invention employs an independent RF chain for each carrier frequency for both transmit and receive paths.

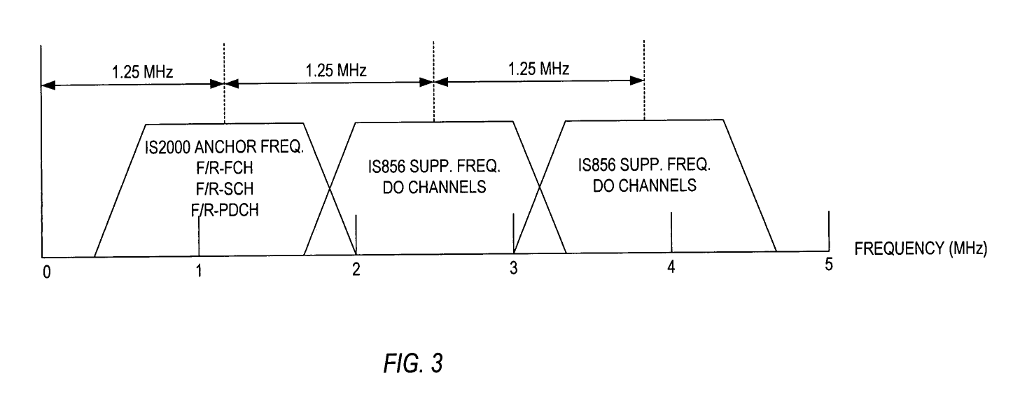

The present invention makes it possible to use different air interfaces for different carrier frequencies as shown in FIG. 3. As shown in FIG. 3, the anchor frequency conforms to the cdma2000 standard with a full array of circuit-switched and packet-switched channels as specified in Revisions C and D of the cdma2000 standard to maintain backward compatibility. The supplemental frequencies include channel structures based on the IS856 standard, which is generally known as 1×EV-DO (1st Evolution Data Only). The IS856 standard specifies a high data rate (HDR) forward and reverse packet data channels for packet-data may be overlaid on an existing circuit-switched or packet-switched network. A 1×EV-DO network does not include support for legacy circuit-switched channels. The F/R-PDCHs and associated control channels as specified in the IS856 standard are referred to herein as DO channels.

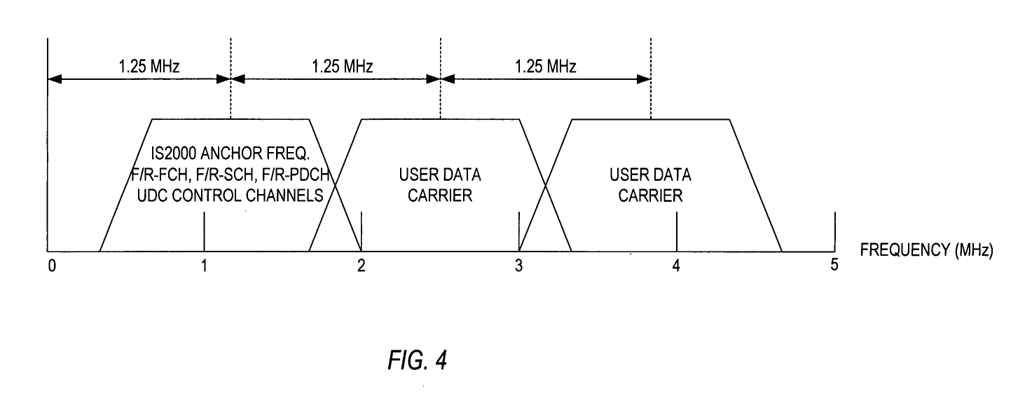

FIG. 4 illustrates a multicarrier system that combines a 1×EV-DV carrier with one or more user data carriers. In this embodiment, the 1×EV-DV carrier serves as the anchor frequency and maintains a backward compatibility with existing 1× systems. Alternatively, the anchor frequency may include a channel structure as specified in 1×EV-DO. All of the control channels are located on the anchor frequency. The supplemental frequencies may use a newly-defined channel structure to efficiently carry user data without having the burden of defining physical channels to carry control signaling. The supplemental frequencies can be dynamically added/removed from a connection. The supplemental frequencies are designed to carry only user data with all the related control information being carried over newly defined control channels (UDC control channel) on the anchor frequency. The supplemental frequencies are used to augment the user data traffic carried over the anchor frequency.

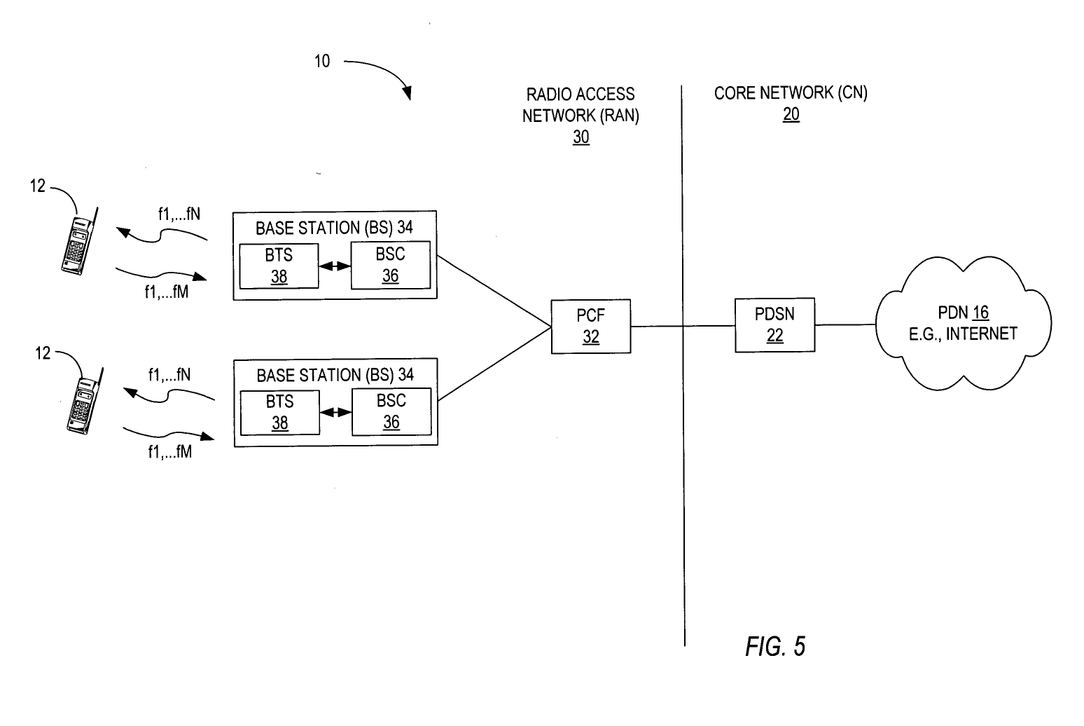

FIG. 5 illustrates a wireless communication network 10 according to one embodiment of the present invention. FIG. 5 illustrates a wireless communication network 10 configured according to the cdma2000 (IS2000) standards. Wireless communication network 10 comprises a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile station 12. Core network 20 adds and removes IP streams to and from the RAN 30 and routes packets between the external packet data network 16 and the RAN 30.

RAN 30 connects to the core network 20 and gives mobile stations 12 access to the core network 20. RAN 30 includes a Packet Control Function (PCF) 32 and one or more Base Stations (BSs) 34. The primary function of the PCF 32 is to establish, maintain, and terminate connections to the PDSN 22. The BSs 34 provide the mobile stations 12 with radio access to the network 10. The BSs 34 include a Base Station Controller (BSC) 36 and one or more Base Transceiver Stations (BTS) 38. The BSC 36 is the control part of the base station 34. The BSC 36 manages the radio resources within their respective coverage areas. BTSs 38 are the part of the base station 34 that includes the radio equipment for communicating over the air interface with mobile stations 12 and is normally associated with a cell site. While FIG. 5 illustrates a separate BSC 36 for each BS 34, those skilled in the art will appreciate that a single BSC 36 may comprise the control part of multiple base stations 34. In other network architectures based on other standards, the network components comprising the base station 34 may be different but the overall functionality will be the same or similar. In one exemplary embodiment of the invention, the RLP and MC 60, 70 sublayers are implemented at the BSC 36, while the multiplexing and QoS sublayer 62 and packet data control functions 64 are implemented at the BTS 38.

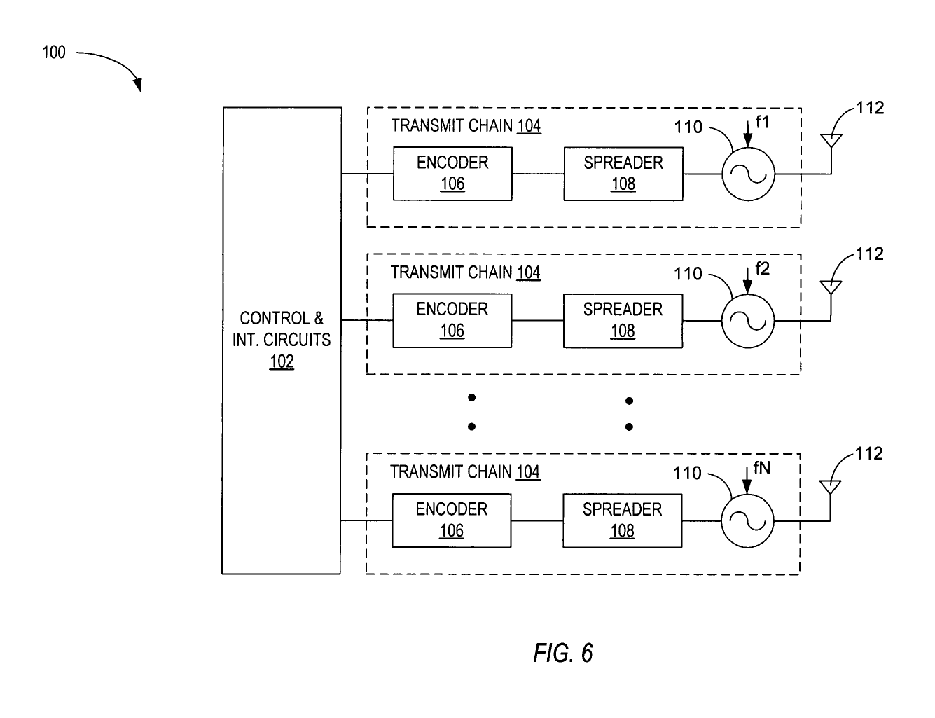

FIG. 6 illustrates a transmitter 100 according to one embodiment of the present invention for transmitting signals from a first station to a second station. The transmitter 100 may be incorporated into a mobile station 12 for transmitting signals on an uplink channel to a base station 34, or may be incorporated in a base station 34 for transmitting signals on a downlink channel to a mobile station 12. Transmitter 100 comprises a control and interface circuit 102 that divides and reassembles RLP streams as previously described. Each substream is applied to a corresponding transmit chain 104. Each transmit chain 104 includes an encoder 106, spreader 108, modulator 110, and transmit antenna 112. The encoder 106 encodes the substream using error detection and/or correction codes. The coded substream output from the encoder 106 is spread in spreader 108 using a spreading code assigned to the mobile station 12 to generate a wideband signal. The same spreading code may be used to spread the signal in each transmit chain 104. Alternatively, different transmit chains 104 may use different spreading codes. After spreading, the modulator 110 modulates the wideband signal output by the spreader 108 onto an RF carrier for transmission to a remote station. Each transmit chain 104 is assigned a different carrier frequency. There is no need for the carrier frequencies to be contiguous, though some embodiments may benefit from having contiguous carrier frequencies.

The aggregate transmit data rate for the transmitter 100 is equal to the sum of the data rates for each transmit chain 104. The data rate for each transmit chain 104 may be independently controlled. This is useful when one carrier frequency is congested. In such circumstances, the control and interface circuit 102 may increase the data rate on the least congested carrier frequencies and decrease the data rate on the most congested carrier frequencies.

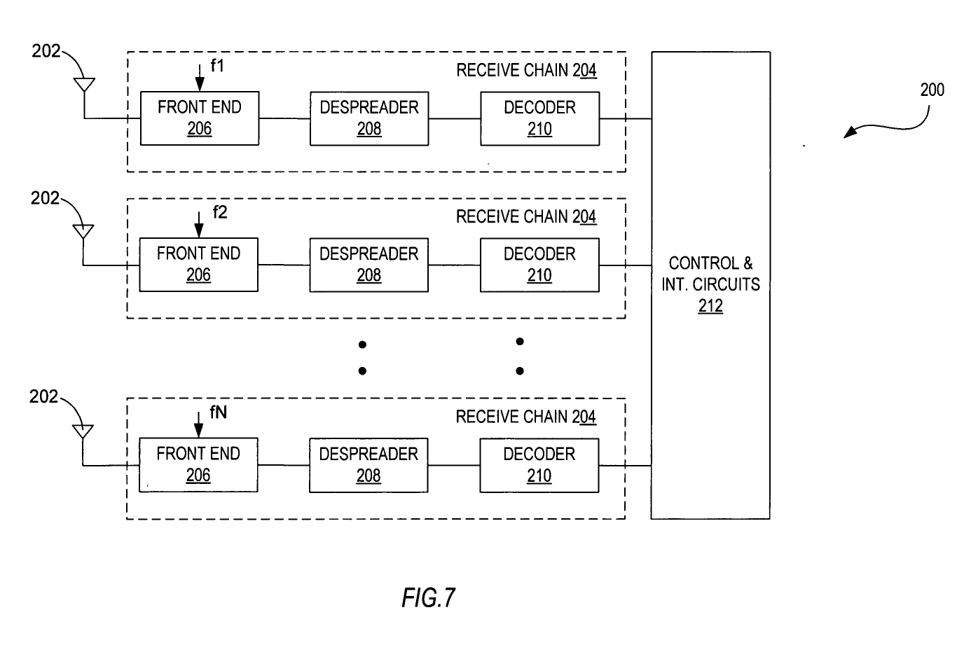

FIG. 7 illustrates a receiver 200 according to one embodiment of the present invention for receiving signals transmitted by the transmitter 100 shown in FIG. 6. The receiver 200 comprises a plurality of receive antennas 202, each of which is coupled to a receive chain 204. Each receive chain 204 comprises a receiver front end 206, despreader 208, and decoder 210. The front end 206 filters, amplifies, and downconverts the received signal to the baseband frequency. Despreader 208 despreads the received baseband signal and outputs received signal samples to the decoder 210. Decoder 210 decodes the received signal samples to produce an output bitstream. In the absence of bit errors, the output bitstream from the decoder 210 will be the same as a substream input to a corresponding transmit chain 104 at the transmitter 100. The output bitstreams from each receive chain 204 are recombined by the control interface circuits 212 at the receiving station to produce the original input bitstream.

In operation, the BSC 36 selects the number of carrier frequencies for a communication link between a mobile station 12 and a base station 34. The selective multicarrier transmission scheme may be used on a forward link, a reverse link, or both. Different carrier frequencies may be used for the forward and reverse links. Further, the number of carriers assigned to forward and reverse links may be different. The BSC 36 may use upper layer (Layer 3) signaling to notify the mobile station 12 of the number and identities of the selected carrier frequencies. Examples of messages that can carry this information include the Universal Handoff Direction Message (UHDM), Service Connect message, and In-Traffic System Parameters Message (ITSPM).

Alternatively, the BSC 36 can send signaling messages to the mobile station 12 over the forward packet data control channel (F-PDCCH) and/or over the Reverse Grant Channel (R-GCH) for the forward and reverse links respectively. In one embodiment of the invention, a new frequency assignment message is used to indicate forward link frequency assignments for the F-PDCH. The frequency assignment message includes the assigned MAC_ID of the user and an 8-bit frequency assignment bitmap identifying the carrier frequencies to use for subsequent F-PDCH transmissions. An 8-bit bitmap allows up to 8 supplemental frequencies to be activated for forward link communications. If more frequencies need to be assigned, then Layer 3 signaling can be used.

On the reverse link, the grant channel can be used to indicate the available frequencies to use. The frequency assignment message for the reverse link includes the MAC_ID of the user and a frequency assignment bitmap indicating the assigned carrier frequencies. The frequency assignment bitmap may comprise 2 bits to indicated the following:
‘00’: deactivate supplemental frequencies
‘01’: activate Frequency Group 1 (deactivate Frequency Groups 2 & 3)
‘10’: activate Frequency Group 2 (deactivate Frequency Groups 1 & 3)
‘11’: activate Frequency Group 3 (deactivate Frequency Groups 1 & 2)
   A frequency group is a group of frequencies that are available for the reverse link. The frequency groups are not necessarily disjoint and may include one or more of the same carrier frequencies. The mobile station 12 is granted the frequencies to use, but is allowed to determine the carrier frequencies that it wants to use. The mobile station 12 indicates the carrier frequencies on the R-PDCCH.

To determine the number of carrier frequencies to assign to a connection between a mobile station 12 and a base station 34, the BSC 36 can take into account factors such as the RLP queue level for each carrier frequency, QoS requirements, the average effective data transmission rate on each carrier frequency, a desired data transmission rate, and the loading on each carrier frequency. When the number of carriers assigned to a communication link (either forward or reverse link) is insufficient to support a desired data rate or when the queue level is high, the BSC 36 can add additional carrier frequencies to the communication link. Conversely, when the bandwidth of the assigned carrier frequencies is not being fully utilized or the queue level is low, the BSC 36 can drop a carrier frequency from a communication link. The BSC 36 could also substitute one carrier frequency with another while maintaining the number of carrier frequencies the same. The substitution of one carrier frequency for another may be useful when one carrier frequency is congested.

In one embodiment of the invention, the BSC 36 may add a carrier frequency to the forward link when the buffer level exceeds a predetermined high level for a predetermined period of time, or may drop a carrier frequency if the buffer levels drop below a predetermined low level for a predetermined period of time. For the reverse link, the mobile station can request that a new carrier frequency be added or dropped based on its buffer levels, or it can report its buffer levels to the BSC 36. Alternatively, the BSC 36 may predict expected traffic levels on the reverse link based on the amount of traffic experienced. The buffer level values used for making add/drop decisions may comprise filtered buffered values based on some time constant and not instantaneous values.

Rate control for forward and reverse packet data channels is handled at the BTS 38 by the packet data control function 64. As shown in FIG. 1, the packet data control function 64 is duplicated for each carrier frequency. The forward and reverse packet data channel on each carrier may be as specified in Revision D of the cdma2000 standard, commonly known as 1×EV-DV. In this case, each carrier frequency may include all the channels supporting forward and/or reverse packet data channels as specified by the cdma2000 standard. The data transmission rate for each carrier frequency is independently controlled.

For the forward F-PDCH, the Forward Packet Data Control Channel (F-PDCCH) indicates separately for each carrier frequency whether the mobile station 12 is scheduled to receive data. The mobile station 12 sends Channel Quality Indicator (CQI) reports to the base station 34 for each carrier frequency over the Reverse Channel Quality Indication Channel (R-CQICH). Based on the CQI reports from the mobile station 12, the packet data control function 64 schedules the mobile station 12 and determines the data transmission rate. Data packets transmitted by the base station 34 to the mobile station 12 on each carrier frequency are acknowledged by the mobile station 12 on a Reverse Acknowledgement Channel (R-ACKCH).

For the R-PDCH, the number of frequencies used for the reverse link connection depends of the amount of data to be sent by the mobile station 12 and the congestion experienced by the base station 34. The mobile station 12 reports the power headroom and buffer levels to the base station 34 the same as in a “1×” system and the base station 34 schedules the data transmission rate separately for each carrier frequency assigned to the reverse link connection. Rate scheduling is performed by the packet data control function 64 at the BTS 38. The mobile station 12 reports power headroom separately for each carrier frequency, and sends a common buffer level report for all carrier frequencies. The buffer level may be reported only on the anchor frequency, or on all carrier frequencies. Rate assignments and rate grant decisions are made on a carrier frequency basis. Thus, the data transmission rate of the mobile station 12 may differ on each carrier frequency. Further, the mobile station 12 may be denied permission to transmit on one carrier frequency due to congestion at the base station 34 even though the carrier frequency has been assigned by the BSC 36.

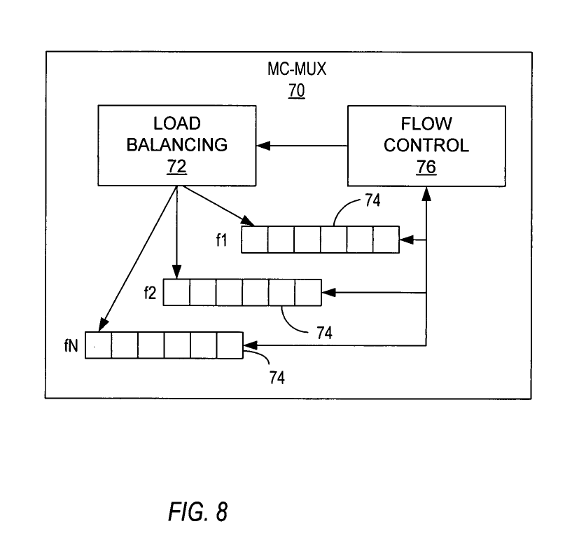

Load balancing is performed by the MC sublayer 70, which as noted above, may be located at the BSC 36. FIG. 8 illustrates the MC sublayer 70 in more detail. The MC sublayer 70 includes load balancing function 72 to distribute RLP packets across multiple carrier frequencies. A separate transmit queue 74 is maintained for each carrier frequency supporting a connection. The buffer size for each carrier frequency is variable depending on the data rate that the mobile station 12 is achieving for each carrier frequency. A flow control function 76 monitors the average data rate on each carrier frequency and adjusts the buffer sizes for each carrier frequency accordingly. As the average data rate increases, the buffer size is increased and as the average data rate decreases, the buffer size decreases. The flow control function 76 indicates the buffer size for each carrier frequency to the load balancing function 72, which apportions the incoming RLP packets across the carrier frequencies in a proportional round-robin fashion. That is, the load balancing function 72 apportions packets according to the average data rate on each carrier frequency in a sector. When there is a difference in the average data rate for each carrier frequency, the load balancing function 72 gives the better performing carrier frequencies proportionally more RLP packets. If the average data rate is equal, the load balancing function 72 allocates each carrier frequency an equal number of packets.

As the mobile station 12 moves out of the coverage area provided by one of its assigned carrier frequencies, the load balancing function 72 may reassign RLP packets queued for that carrier frequency to another carrier frequency. As the mobile station 12 moves out of the coverage area of a particular carrier frequency, the average data rate will tend towards zero thereby reducing the number of RLP packets that need to be reassigned. If the BS 34 can anticipate when the mobile station 12 is moving out of the coverage area for a particular carrier frequency, it can gradually reduce the window size for that carrier frequency to zero before the mobile station 12 completely loses coverage on that carrier frequency so that no RLP packets need to be reassigned.

The load balancing function 72 may also redistribute RLP packets if the packet latency for one of the carrier frequencies increases above some predetermined threshold. The flow control function 76 monitors the packet latency for each carrier frequency and can signal the load balancing function 72 if the packet latency for one carrier frequency exceeds the packet latency for the others by more than a predetermined amount. The load balancing function 72 can redistribute RLP packets from the lagging carrier frequency to other carrier frequencies.

The present invention is particularly useful for transmitting high speed or ultra high speed packet data between a mobile station 12 and a base station 34. In general, the number of carrier frequencies allocated to a communication link (either forward link or reverse link) between a mobile station 12 and a base station 34 will depend on a desired aggregate data transmission rate. The desired aggregate data transmission rate may be based on factors such as the amount of data that needs to be transmitted, quality of service, and network congestion. Once a desired aggregate data transmission rate is determined, the BSC 36 selects the carrier frequencies for the communication link. The specific carrier frequencies may be selected to balance the load across the available carrier frequencies.

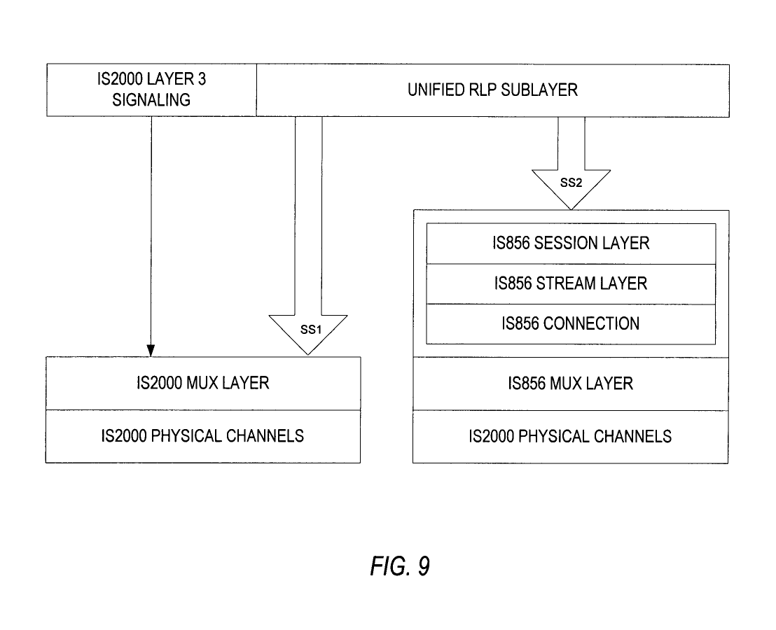

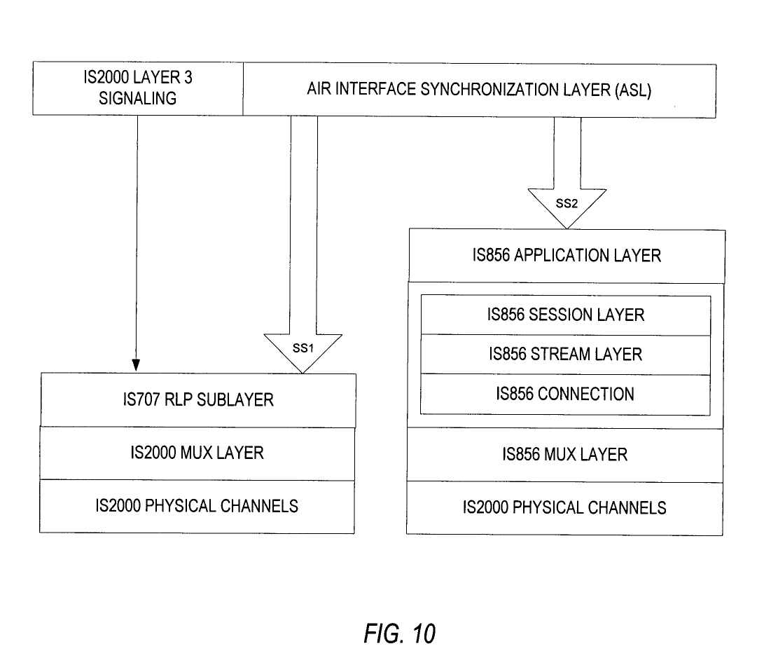

FIGS. 9 and 10 illustrate techniques that may be employed where a mixture of IS2000 and IS856 carriers are employed. Referring to FIG. 9, an RLP stream for a mobile station 12 is divided into multiple parallel substreams by the MC sublayer 70. FIG. 9 illustrates two substreams denoted substream 1 (SS1) and substream 2 (SS2). Substream 1 passes through an IS2000 protocol stack and is transmitted over an IS2000 carrier to the mobile station 12. Similarly, substream 2 passes through an IS876 protocol stack and is transmitted over an IS856 carrier to the mobile station 12. Transmissions received from the mobile station 12 pass upward through the protocol stacks to the RLP layer.

The partitioning of the RLP streams over the different carrier frequencies happens below the RLP sublayer 60. The RLP sublayer 60 ensures that there is in-order delivery of packets to the upper layer independent of the multiplexing sublayer layer 62 or the physical channels. In this embodiment, the RLP sublayer 60 accounts for the different radio interfaces and ensures that air interface compatible packets are delivered to the different IS2000 and IS856 protocol stacks. Because existing implementations of the RLP sublayer 60 are air interface dependent, this approach requires modification of the existing RLP protocol to handle multiple air interfaces. According to the present invention, a uniform RLP protocol is provided to account for differences in the air interfaces.

FIG. 10 illustrates an alternate approach that allows existing RLP implementations for IS2000 and IS856 air interfaces to be used without changes. In the embodiment shown in FIG. 10, a new protocol layer, referred to herein as the air interface synchronization layer (ASL), is defined to ensure the ordered sequencing of bits delivered to different carrier frequencies. This approach simplifies standards development and reduces development costs but will add additional overhead to accommodate ASL headers.

In any case, those skilled in the art should appreciate that the present invention is not limited by the foregoing discussion, nor by the accompanying figures. Rather, the present invention is limited only by the following claims and their reasonable legal equivalents.

1. A selective multiband transmission method for transmitting packet data between a base station and a mobile station, the method comprising:
dividing an input packet data stream into one or more substreams depending on a selected number of carrier frequencies;
transmitting each substream on a corresponding carrier frequency; and
selectively varying the number of carrier frequencies during transmission of said packet data.

2. The method of claim 1 wherein dividing an input packet data stream into one or more substreams comprises dividing the input packet data stream proportionally based on an average data transmission rate for each substream.

3. The method of claim 1 further comprising designating a selected carrier frequency as an anchor frequency for said mobile station, wherein said input packet data stream is transmitted between said mobile station and said base station on said anchor frequency when only one carrier frequency is selected.

4. The method of claim 1 wherein selectively varying the number of carrier frequencies during transmission of said packet data comprises assigning one or more supplemental frequencies as needed to said mobile station depending on a desired aggregate data transmission rate.

5. The method of claim 4 wherein each carrier frequency includes at least one packet data channel for transmission of packet data to said mobile station.

6. The method of claim 5 further comprising transmitting control information over said anchor frequency to control packet data transmission over a packet data channel for at least one of said supplemental frequencies.

7. The method of claim 6 further comprising transmitting control information for all packet data channels over said anchor frequency.

8. The method of claim 5 wherein said anchor frequency includes a control channel supporting packet data transmission over a packet data channel on at least one supplemental frequency.

9. The method of claim 8 wherein said anchor frequency includes a shared control channel supporting packet data transmission over two or more packet data channels on said supplemental frequencies.

10. The method of claim 1 further comprising sending a frequency assignment message from the base station to said mobile station.

11. The method of claim 10 wherein said frequency assignment message is a layer 3 message.

12. The method of claim 11 wherein said frequency assignment message for forward link communications is transmitted on a packet data control channel.

13. The method of claim 11 wherein said frequency assignment message for reverse link communications is transmitted on a grant control channel

14. The method of claim 11 wherein said frequency assignment message includes a frequency bitmap indicating the selected carrier frequencies for packet data transmissions.

15. The method of claim 1 wherein said packet data is transmitted from the base station to said mobile station.

16. The method of claim 15 further comprising:
receiving channel quality feedback at said base station from said mobile station for each assigned carrier frequency; and
independently controlling a data transmission rate for each carrier frequency based on said channel quality feedback.

17. The method of claim 1 wherein said packet data is transmitted from the mobile station to the base station.

18. The method of claim 17 further comprising:
receiving power headroom reports at said base station from said mobile station for each assigned carrier frequency;
receiving a buffer level report from said mobile station; and
independently controlling a data transmission rate for each carrier frequency based on said power headroom reports and said buffer level report.

19. The method of claim 18 wherein power headroom is reported separately for each assigned carrier frequency for reverse link communications.

20. The method of claim 18 wherein a common buffer level is reported for all carrier frequencies.

21. A communication device for transmitting packet data between a base station and a mobile station, the communication device comprising:
a multicarrier multiplexing unit for dividing an input packet data stream into one or more substreams depending on a selected number of carrier frequencies;
a transmitter for transmitting each substream on a corresponding carrier frequency; and
a control unit for varying the number of carrier frequencies during transmission.

22. The communication device of claim 21 wherein the multicarrier multiplexing unit divides the input packet data stream into one or more substreams proportionally based on an average data transmission rate on each carrier frequency.

23. The communication device of claim 21 wherein said control unit designates a selected carrier frequency as an anchor frequency, and wherein said input packet data stream is transmitted between said mobile station and said base station on said anchor frequency when only one carrier frequency is selected.

24. The communication device of claim 23 wherein said control unit selectively varies the number of carrier frequencies during transmission of said packet data by assigning one or more supplemental frequencies as needed to said mobile station depending on a desired aggregate data transmission rate.

25. The communication device of claim 24 wherein control information to control packet data transmissions over packet data channels for at least one supplemental frequency is carried on said anchor frequency.

26. The communication device of claim 25 wherein control information for all packet data channels is carried on said anchor frequency.

27. The communication device of claim 24 wherein said anchor frequency includes a control channel supporting packet data transmission over a packet data channel for at least one supplemental frequency.

28. The communication device of claim 27 wherein said anchor frequency includes a shared control channel supporting packet data transmission over two or more packet data channels on said supplemental frequencies.

29. The communication device of claim 26 wherein a single packet data control channel on an anchor frequency supports packet data channels for a plurality of carrier frequencies.

30. The communication device of claim 21 wherein the communication device comprises a base station.

31. The communication device of claim 30 wherein said control unit sends a frequency assignment message to said mobile station.

32. The communication device of claim 31 wherein said frequency assignment message is a layer 3 message.

33. The communication device of claim 31 wherein said frequency assignment message for forward link communications is transmitted on a packet data control channel.

34. The communication device of claim 31 wherein said frequency assignment message for reverse link communications is transmitted on a grant control channel

35. The communication device of claim 31 wherein said frequency assignment message includes a frequency bitmap indicating the selected carrier frequencies for packet data transmissions.

36. The communication device of claim 30 wherein said control unit independently controls a data transmission rate for each forward link carrier frequency based on a channel quality feedback.

37. The communication device of claim 36 wherein said data transmission rates for said forward link carrier frequencies are based on channel quality feedback from said mobile station for each forward link carrier frequency.

38. The communication device of claim 30 wherein the control unit independently controls a data transmission rate for each reverse link carrier frequency.

39. The communications device of claim 38 wherein the control unit controls the data transmission rate for reverse link carrier frequencies based on power headroom reports and buffer level reports from said mobile station.

40. The communication device of claim 39 wherein power headroom is reported separately for each assigned carrier frequency for reverse link communications.

41. The communication device of claim 39 wherein a common buffer level is reported for all carrier frequencies.

42. The communication device of claim 21 wherein said communication device comprises a mobile station.
